(19) United States
(12) Patent Application Publication
(10) Pub. No.: US 2026/0200198 A1
(43) Pub. Date: Jul. 16, 2026

(54) BRAKE SYSTEM AND METHOD FOR A DUNNAGE CONVERSION MACHINE

(71) Applicant: Ranpak Corp., Concord Township, OH (US)

(72) Inventors: Koen RAS, Sittard (NL); Jordy VAN DER KAAP, Schimmert (NL)

(73) Assignee: Ranpak Corp., Concord Township, OH (US)

(21) Appl. No.: 19/138,508

(22) PCT Filed: Dec. 4, 2023
(86) PCT No.: PCT/US2023/082353

§ 371 Date: Jun. 12, 2025

Related U.S. Application Data
(60) Provisional application No. 63/386,987, filed on Dec. 12, 2022.

(51) Int. Cl. B31D 5/00; B65H 23/06

(52) U.S. Cl. CPC B31D 5/0039; B65H 23/06; B31D 2205/0023; B31D 2205/0088; B65H 2402/20

(57) ABSTRACT

A brake assembly for a dunnage conversion machine includes a first arm and a second arm rotationally affixed to a first location and a second location on a mounting surface, respectively. The arms include a brake pad disposed at an end opposite the mounting surface. The second mounting location is spaced apart from the first mounting location, and the second arm crosses over the first arm. The brake assembly also includes a spring disposed between the first arm and the second arm. The spring biases the brake pads apart from one another. When a roll of sheet stock material is mounted over the brake pads, the weight of the roll and the spring cooperate to provide a sheet material with a consistent tension from the roll to the dunnage conversion machine.

### FIELD OF THE INVENTION

The present invention relates generally to the field of dunnage conversion systems, and more particularly to a braking system for a supply of sheet material for a dunnage conversion machine.

### BACKGROUND

In the process of packing an article in a packaging container to ship the article from one location to another, a protective packaging material (generally referred to as a dunnage product) is often placed in the packaging container with the article. The dunnage product is included to fill any voids or to cushion the article during the shipping process. Paper packing material is an ecologically-friendly packing material that is recyclable, biodegradable, and composed of a renewable resource. While paper in sheet form could possibly be used as a protective packaging material, it may be preferable to convert the sheets of paper into a dunnage product having a lower density than the paper used to make the dunnage product.

Dunnage products take many forms. For example, expandable slit-sheet packing material, also referred to as slit-sheet material, slit-sheet stock material, die-cut sheet stock material, or slit material, is useful as a cushioning material for wrapping articles and as a void-fill material for packages. The slit-sheet stock material has a plurality of slits generally arrayed in parallel rows across a width dimension of the slit-sheet stock material. When a stretching force is applied to this slit-sheet material in a length or longitudinal direction transverse the direction of the slits, the slit-sheet material expands in both length and thickness, while decreasing in width, to yield an increase in volume and comparable decrease in density. As used herein, the term expanding, therefore, refers to a three-dimensional expansion or a volume expansion. Exemplary slit-sheet paper packing material, and the manufacturing thereof, are described in greater detail in U.S. Pat. Nos. 5,667,871 and 5,688,578, the disclosures of which are hereby incorporated herein by reference in their entireties.

### SUMMARY

The present disclosure describes a dunnage conversion machine, and more particularly a brake assembly for a supply of sheet material for a dunnage conversion machine. The brake assembly uses the weight of a roll of sheet material, which decreases as sheet material is dispensed from the roll, in combination with a spring, a support linkage, and a pair of brake pads inserted into a hollow core of the roll, to resist rotation of the roll and thereby automatically maintain a constant tension.

As the sheet material is drawn from the roll and converted into dunnage pads, the weight of the roll decreases. As the weight of the roll decreases, so does the friction force acting on the core of the sheet material. Thus, the roll of sheet material will remain in constant tension. Maintaining constant tension is advantageous because dunnage conversion machines typically operate in a start-stop manner. In conventional designs, as the machine stops the roll of sheet material can overrotate, or overrun, causing a loose loop of sheet material to form between the roll and the conversion machine. This loose loop is then taken up by the machine when it restarts, with nearly zero tension in the sheet material until the slack of the loose loop is taken up. Then the tension in the sheet material spikes as the machine continues to draw sheet material from the roll, and has to overcome the inertia of the roll at rest before a steady-state level of tension is achieved. This low tension condition followed by the sudden high tension condition can lead to nonuniform properties in the resulting dunnage product. And the sudden high-tension condition can cause the sheet material to tear or jam in the machine, leading to further stoppage of the machine and downtime, as well as wasted sheet material, as the tearing or jamming problems are corrected.

The present disclosure minimizes or prevents the overrun problem by automatically imparting a resistance force to rotation of the roll, thereby maintaining tension in the sheet material as it is drawn off the roll, slowing rotation and minimizing or eliminating overrun when the dunnage conversion machine stops. Providing more uniform tension in the sheet stock material as it is drawn from the roll also promotes a more uniform, higher quality dunnage product.

An exemplary brake assembly 10 for a dunnage conversion machine includes a first arm rotationally affixed to a first location on a mounting surface of the dunnage conversion machine at a first end of the first arm. A first brake pad is disposed at a second end of the first arm. A second arm is rotationally affixed to a second location on the mounting surface of the dunnage conversion machine at a first end of the second arm. A second brake pad is disposed at a second end of the second arm. The second mounting location is spaced apart from the first mounting location, and the second arm crosses over the first arm. The brake assembly also includes a spring disposed between the first and second arm. The spring biases the first brake pad and the second brake pad apart from one another.

The brake assembly may include a linkage arm that is rotationally affixed between the first arm and the second arm.

The brake assembly may include the linkage arm attached at a first intermediate position between the first end and the second end of the first arm and attached at a second intermediate position between the first end and the second end of the second arm.

The linkage arm may be attached at an intermediate position between the first end and the second end of the first arm and attached at a second intermediate position between the first end and the second end of the second arm.

The brake assembly may include a brake configuration wherein the first brake pad is a half cylinder with a curved outer braking surface, and the second brake pad may be a half cylinder with a curved outer braking surface.

The outer braking surface of the first brake pad and the outer braking surface of the second brake pad are configured to face away from one another.

The roll of sheet material may include a hollow cylindrical core around which the sheet material is wound, and the brake assembly may be configured such that the first brake pad and the second brake pad can be received in the hollow cylindrical core.

The first and second brake pads may be rotationally received within the hollow cylindrical core.

The brake assembly may include the first location positioned such that it is spaced vertically apart from the second location.

The first location may be positioned such that is spaced above the second location.

The brake assembly may include the first brake pad and second brake pad including a frictional element.

The frictional element may include a friction coating disposed along the length of the brake pads.

The frictional element may include a plurality of frictional engagement features disposed along the length of an outer surface of the brake pads.

An exemplary dunnage conversion machine for producing a dunnage pad from a sheet material provided on a roll may include one or more of the following features: a support for the roll of sheet material, a conversion assembly that converts the sheet material into a dunnage product, the conversion assembly including a pair of rotatable members that draw sheet material form the roll, and the support including a brake assembly.

The dunnage conversion machine may include a frame that defines the mounting surface.

The dunnage conversion machine may include a vertical configuration for the mounting surface.

An exemplary method for producing a dunnage pad from a sheet material includes one or more of the following steps, (i) providing a roll of sheet material having a hollow cylindrical core, (ii) supporting the roll of sheet material on an exemplary brake device with first and second brake pads received in the core, (iii) advancing the sheet material from the roll in a downstream direction to a dunnage conversion machine, converting the sheet material into a dunnage product with a lower density than a density of the sheet material, (iv) stopping the advancing of the sheet material, and (v) slowing rotation of the roll of sheet material with friction resistance from the exemplary brake device.

### BRIEF DESCRIPTION OF THE DRAWINGS

FIG. 1 is a side elevation view of an exemplary brake assembly for a conversion machine with a roll of sheet stock material;

FIG. 2 is a perspective view of the brake assembly of FIG. 1 with the roll of sheet stock material removed to better illustrate the brake assembly;

FIG. 3 is a side elevation view of an exemplary system for producing a dunnage pad using the brake assembly of FIG. 2;

FIG. 4 is a perspective view of the system shown in FIG. 3;

FIG. 5 is a flow chart of an exemplary method of producing a dunnage pad from sheet material.

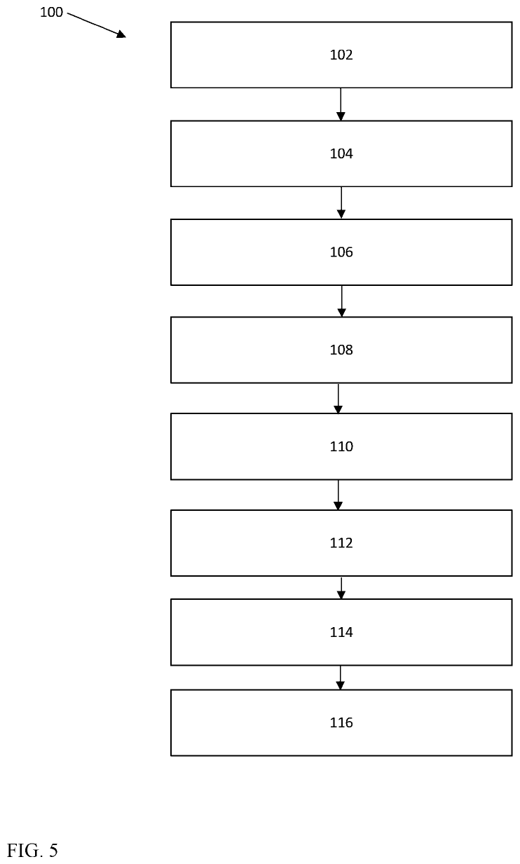

### DETAILED DESCRIPTION

The present disclosure describes a dunnage conversion machine 12, and more particularly a brake assembly 10 for a supply of sheet material for a dunnage conversion machine 12. The present disclosure utilizes the weight of an associated roll 14 of sheet material 15 to resist rotation of the roll and thereby automatically maintain a constant tension. An exemplary brake assembly 10 may include the roll 14 of sheet material 15, which decreases in weight as sheet material 15 is dispensed from the roll 14, in combination with a spring 42, a support linkage 44, and a pair of brake pads 28, 30 inserted into a hollow core 16 of the roll, to resist rotation of the roll 14 and thereby automatically maintain a constant tension. A common issue during the operation of dunnage conversion machines 12 is over rotation, or overrun, of the roll of sheet material 14 on the dunnage conversion machine 12 once the machine 12 is stopped. This overrun causes slack in the sheet material 15. This slack creates problems because before the sheet material 15 can be advanced further down in the dunnage conversion machine 12 the slack must be removed from the line. Correcting the slack in the line causes significant line downtime or if not corrected it can result tearing and wasted material. The present disclosure addresses these problems because the brake assembly 10 utilizes the weight of the associated roll of sheet material 14 in order to control braking speed and maintain tension in the roll of sheet material 14.

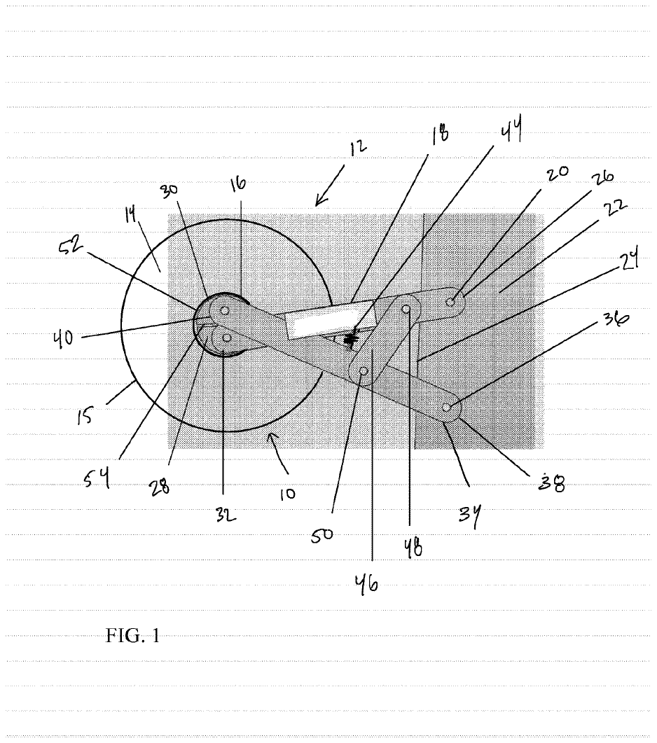

Turning now to the drawings, and initially to FIG. 1, FIG. 1 shows a general schematic representation of an exemplary brake assembly 10 for an exemplary dunnage conversion machine 12 for producing a dunnage pad from a roll of sheet material 14. The roll of sheet material 14 includes an associated hollow cylindrical core 16 around which the sheet material 15 is wound to form the roll 14. The roll of sheet material 14 may be any suitable sheet material 15 such as paper (e.g., kraft paper, tissue paper, etc.), plastic sheets, metal foil, or any other combination thereof. An exemplary dunnage conversion machine 12 uses a die-cut sheet stock material, with a plurality of cuts in the sheet material, arranged in an array of a plurality of rows extending across the width of the sheet material. When subjected to tension across cuts, the cuts open and the sheet material expands in length and width to form an expanded sheet that is useful in forming a dunnage product that is less dense than the sheet material.

The brake assembly 10 supports the roll of sheet material 14 for conversion by the dunnage conversion machine 12. The brake assembly 10 includes a first arm 18 which is rotationally affixed at first location 20 on a mounting surface 22 of a frame 24 at a first end 26 of the first arm 18. A first brake pad 28 is disposed at a second end 32 of the first arm 18. The brake assembly 10 further includes a second arm 34 which is rotationally affixed at a second location 36 on the mounting surface 22 at a first end 38 of the second arm 34. A second brake pad 30 is disposed at a second end 40 of the second arm 34. The first location 20 and the second location 36 are vertically spaced apart on the mounting surface 22 such that the first location 20 is positioned above the second location 36. The first arm 18 and the second arm 34 extend outwards from the mounting surface 22 and are configured such that the second arm crosses over the first arm at a cross-over point 42.

The brake assembly 10 further includes a spring 44 disposed between the first arm 18 and second arm 34. More particularly, the spring 44 may be disposed on the first 18 and second arm 34 on either side of the cross over point 42. The spring 44 is configured such that it biases the first brake pad 28 and second brake pad 30 apart from one another. The brake assembly 10 may further include a linkage arm 46 which is attached at a first intermediate position 48 of the first arm 18 and attached at a second intermediate position 50 of the second arm 34. The first intermediate position 48 is disposed between the first end 26 and the second end 32 of the first arm 18. The second intermediate position 50 is disposed between the first end 38 and second end 40 of the second arm 34. The linkage arm 46 may be disposed on either side of the cross-over point 44.

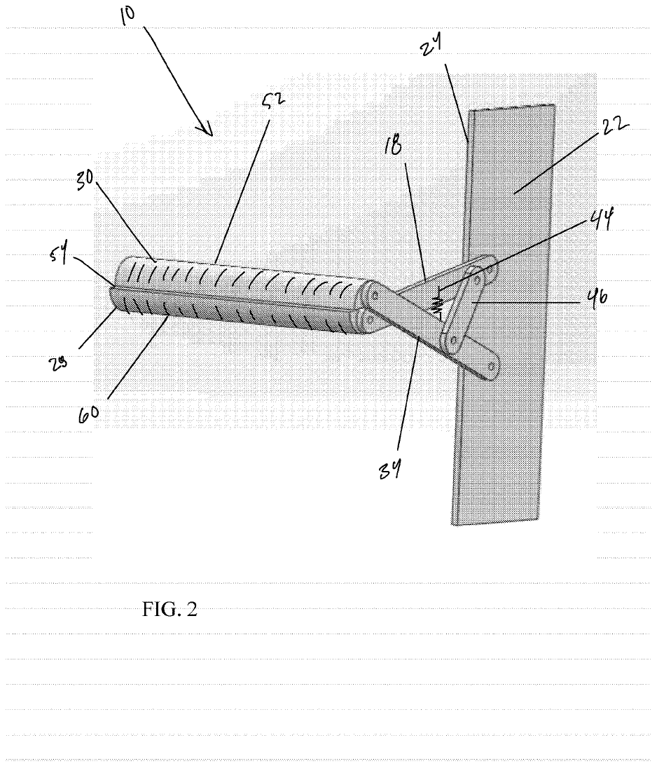

Referring now to FIG. 2, the first and second brake pads 28, 30 may be half cylinders with a curved outer braking surface 52 and a flat inner surface 54. Each half cylinder may be composed of multiple segments. In a further embodiment, the brake pads 28, 30 may be hollow half cylinders such that the brake pads have curved inner surfaces. The brake pads 28, 30 are configured such that they may be rotationally received in the hollow cylindrical core 16 of a roll of sheet material 14. The brake pads 28, 30 are rotationally received in the hollow cylindrical core 16 of a roll of sheet material 14 such that the core 16 may rotate around the brake pads 28, 30. The hollow cylindrical core 16 acts as a bushing that allows the roll of sheet material 14 to rotate around the brake pads 28, 30.

The brake pads 28, 30 are biased away from one another by the spring 44 such that the curved outer braking surfaces 52 of the brake pads 28, 30 make contact with an interior surface of the hollow cylindrical core 16. As the sheet stock material 15 is drawn from the roll 14, its hollow cylindrical core 16 revolves around the brake pads. Contact between the brake pads 28, 30 and core 16 creates a friction force between each brake pad 28, 30 and the core 16. This friction force acts as a braking mechanism to slow the rotation of the hollow cylindrical core 16 of the paper roll and maintain tension of the sheet material in the dunnage conversion machine 12 when the dunnage conversion machine 12 is turned off.

The brake pads 28, 30 may further include a frictional element 60 added on the respective curved braking outer surface 52. The frictional element 60 may be a friction coating disposed along the length of the brake pads 28, 30. The frictional element 60 may further be a fiction sleeve disposed along the length of the brake pads 28, 30. In another exemplary embodiment the frictional element 60 may further be a multitude of frictional engagement features such as ridges, bumps, or other suitable extrusions along the length of the brake pads. The frictional engagement features may be comprised of metal, polymer, or other suitable material for increasing friction to a desired level with respect to the core 16.

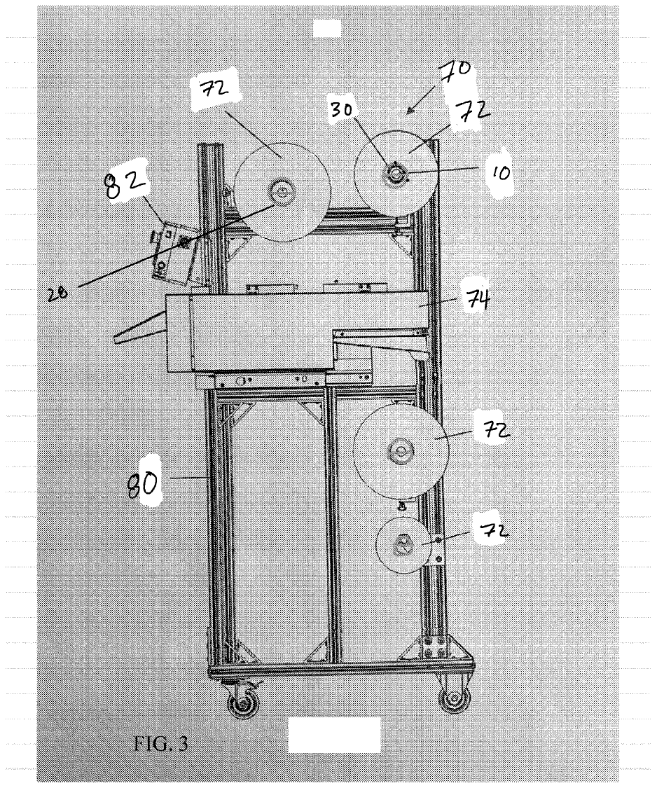

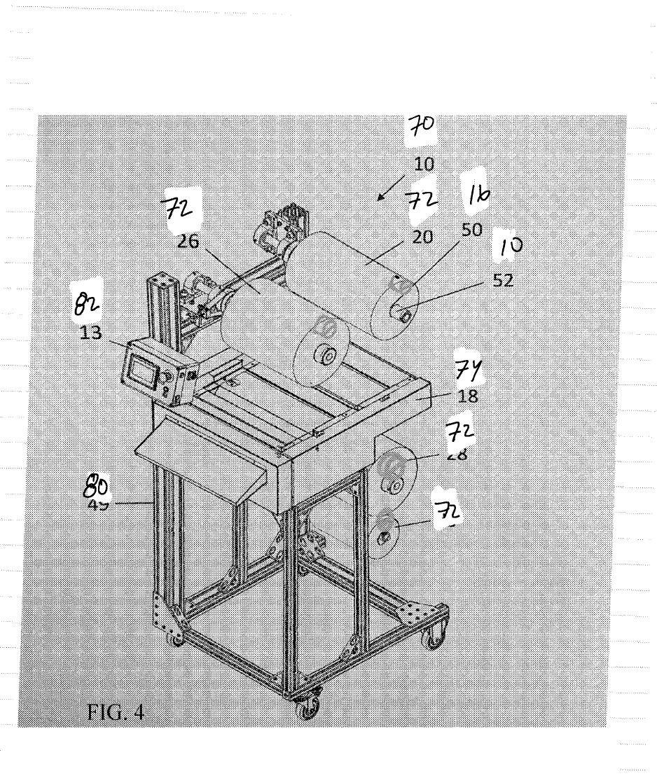

Referring now to FIGS. 3 and 4, which depicts an exemplary system 70 for producing a dunnage pad from sheet material provided on a roll 72. In the illustrated system, several rolls of sheet material 72 and a dunnage conversion machine 74 are mounted on a frame 80 that provides a vertical mounting surface. The system 70 also may include a controller 82 for controlling the operations of the dunnage conversion machine 74. The controller 82 may be a part of the dunnage conversion machine 74, itself, or may be provided separate from the dunnage conversion machine 74. As shown the rolls 72 are mounted on supports which includes the exemplary brake assembly 10 of FIGS. 1 and 2.

The brake assembly 10 operates as a resistance member disposed within the hollow core 16 of the rolls. The brake assembly 10 provides constantly and automatically adjusting frictional resistance because as the roll of sheet material is unwound the frictional resistance will decrease as the weight of the roll of sheet material decreases. The spring 44 biases the brake pads 28, 30 such that the curved outer braking surfaces 52 of the brake pads 28, 30 maintain contact with the inner diameter of the hollow cylindrical core 16. The brake pads 28, 30 maintain frictional resistance by providing pressure against an inner surface of the hollow cylindrical core. When roll 14 is heavy the frictional force is greater because the weight acting on the supports urges the curved outer braking surfaces 52 of the brake pads 28, 30 into the inner surface of the cylindrical core as it rotates. As the sheet stock material is unwound from the roll 14 the weight of the roll 14 decreases. This decrease in weight reduces the friction force which then proportionally reduces the braking force.

This frictional resistance prevents or reduces the degree to which the sheet stock material may overrun and continue to unwind from their respective roll when the conversion machine stops, and ensures that a proper tension is applied as the sheet stock material is drawn from its respective roll. Without this proper tension and resistance, the sheet stock material may unwind from the roll in an uncontrolled and inconsistent manner, resulting in excess unwound sheet stock material or tearing of the sheet stock material that may interfere with the conversion process and decrease the quality of the resulting dunnage products.

An exemplary method 100 of producing a dunnage pad from sheet material is depicted in FIG. 6. The method includes the step 102 of providing a supply of sheet material as a roll 14. As discussed above the sheet material 15 may be any suitable sheet material, such as but not limited to paper (e.g., kraft paper, tissue paper, etc.)

The method 100 also includes the step 104 of supporting the roll of sheet material 14 on a brake assembly 10. The brake assembly 10 may include a frame 24 wherein a first arm 18 and a second arm 34 are rotationally affixed to the frame 24 at a first end 26 of the first arm 18 and a first end 38 of the second arm 34, respectively. The first arm and the second arm 18, 34 are affixed on the frame 24 at respective spaced apart location points 20, 36. The first arm's location point 20 may be spaced vertically from the second arm's location point 36. A first brake pad 28 may be disposed at a second end 32 of the first arm 32. A second brake pad 30 may be disposed at a second end 40 of the second arm 34. The first arm 18 and the second arm 34 extend outwards from the frame 24 and are configured such that the second arm 34 crosses over the first arm at a cross-over point 42. The brake assembly 10 may further include a spring 44 disposed between the first arm 18 and the second arm 34. The brake assembly 10 may also include a linkage arm 46 which is attached at a first intermediate position 48 of the first arm 18 and attached at a second intermediate position 50 of the second arm 34. The linkage arm 46 may be disposed on either side of the cross-over point 42.

The method 100 also includes the step of advancing 106 the sheet material 15 from the supply in a downstream direction. Once the material 15 is advanced downstream into the dunnage conversion machine 12, the method 100 then includes the step 108 of converting the sheet material 15 into a dunnage product with lower density than the sheet material 15. The converting step includes the step 110 of creating tension in the sheet material 15 transverse to the width dimension to cause the sheet material 15 to expand to an expanded state. After creating tension, the method then includes the step 112 of reducing the tension of the sheet material 15. Once tension is fully removed, the sheet material 15 is in an expanded relaxed state such that the density of sheet material 15 is lower than the sheet material on the roll 14.

After a desired length of dunnage product has been produced the dunnage conversion machine 12 is turned off. The method 100 includes the step 114 of applying friction to a core 16 of the roll of sheet material 14 with the brake assembly 10 to resist rotational motion of the roll of sheet material 14. When the machine 12 is turned off, the friction will minimize or eliminate overrun caused by inertia of the roll.

The method also includes the step 116 of connecting overlapping layers of the sheet material 15 in an expanded relaxed state to at least one cover sheet to form a dunnage pad.

In summary, an exemplary brake assembly for a dunnage conversion machine includes a first arm rotationally affixed to a first location on a mounting surface of the dunnage conversion machine at a first end of the first arm. A first brake pad is disposed at a second end of the first arm. A second arm is rotationally affixed to a second location on the mounting surface at a first end of the second arm. A second brake pad is disposed at a second end of the second arm. The second mounting location is spaced apart from the first mounting location, and the second arm crosses over the first arm. The brake assembly also includes a spring disposed between the first arm and the second arm. The spring biases the first brake pad and the second brake pad apart from one another.

Although the invention defined by the following claims has been shown and described with respect to a certain embodiment, equivalent alternations and modifications will occur to others skilled in the art upon reading and understanding this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function of the described integer (i.e., that is functionally equivalent), even though not structurally equivalent to the disclosed structure which performs the function in the herein illustrated exemplary embodiments of the invention. In addition, while a particular feature of the invention may have been described above with respect to only one of several illustrated embodiments, such feature may be combined with one or more other features of the other embodiments, as may be desired and advantageous for any given or particular application.

1. A brake assembly for a dunnage conversion machine, the brake assembly comprising:
a first arm rotationally affixed to a first location on a mounting surface at a first end of the first arm and a first brake pad disposed at a second end of the first arm;
a second arm rotationally affixed to a second location on the mounting surface at a first end of the second arm and a second brake pad disposed at a second end of the second arm, the second arm crosses over the first arm, and the second location is spaced from the first location; and
a spring disposed between the first arm and the second arm to bias the first brake pad and the second brake pad apart from one another.

2. The brake assembly as claimed in claim 1, wherein a linkage arm is rotationally affixed between the first arm and the second arm.

3. The brake assembly as claimed in claim 2, wherein the linkage arm is attached at a first intermediate position between the first end and the second end of the first arm and attached at a second intermediate position between the first end and the second end of the second arm.

4. The brake assembly as claimed in claim 1, wherein the first brake pad is a half cylinder with a curved braking outer surface, and the second brake pad is a half cylinder with a curved outer braking surface.

5. The brake assembly as claimed in claim 4, wherein the outer surface of the first brake pad and the outer surface of the second brake pad are configured to face away from one another.

6. The brake assembly as claimed in claim 1, in combination with a hollow cylindrical core for a roll of sheet material, wherein the first brake pad and the second brake pad are configured to be received in the hollow cylindrical core.

7. The brake assembly as claimed in claim 5, wherein the first and second brake pads are rotationally received within the hollow cylindrical core.

8. The brake assembly as claimed in claim 1, wherein the first location and second location are spaced vertically apart.

9. The brake assembly as claimed in claim 7, wherein the first location is spaced above the second location.

10. The brake assembly as claimed in claim 1, wherein the first brake pad and the second brake pad include a frictional element.

11. The brake assembly as claimed in claim 8, wherein the frictional element is a frictional coating disposed along the length of the brake pads.

12. The brake assembly as claimed in claim 8, wherein the frictional element is a frictional sleeve disposed along the length of the brake pads.

13. The brake assembly as claimed in claim 8, wherein the frictional element includes a plurality of frictional engagement features disposed along the length of an outer surface of the brake pads.

14. A system for producing for producing a dunnage pad from a sheet material provided on a roll, the system comprising:
a dunnage conversion machine;
a support for the roll of sheet material; and
a conversion assembly that converts the sheet material into a dunnage product, the conversion assembly including a pair of rotatable members that draw sheet material from the roll;
wherein the support includes the brake assembly as claimed in claim 1 or any preceding claim.

15. The system as claimed in claim 14, comprising a frame that defines the mounting surface.

16. The system as claimed in claim 14, wherein the mounting surface is vertical.

17. A method for producing a dunnage pad from a sheet material, the method comprising the steps of:
providing a roll of sheet material having a hollow cylindrical core;
supporting the roll of sheet material on a brake device as claimed in claim 1, any preceding claim with the first and second brake pads received in the core;
advancing the sheet material from the roll in a downstream direction;
converting the sheet material into a dunnage product with lower density than the sheet material;
stopping the advancing step; and
slowing the rotation of the roll of sheet material with friction resistance from the brake device.
